(19) United States
(12) Patent Application Publication
(10) Pub. No.: US 2006/0272994 A1
(43) Pub. Date: Dec. 7, 2006

(54) Sealant filter

(76) Inventors: Rodney Erdman, Princeton, MN (US); Eric Berns, Elk River, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/446,254

(22) Filed: Jun. 2, 2006

Related U.S. Application Data
(60) Provisional application No. 60/686,603, filed on Jun. 2, 2005.

(51) Int. Cl. B01D 35/00

(52) U.S. Cl. 210/232; 210/448

(57) ABSTRACT

A filter assembly for filtering viscous fluid materials, including a filter body having an inlet and an outlet, a filter element having an open end and a closed end and a collar structure at the open end. The collar structure is retainable proximate the inlet end such that fluid flows into an interior of the filter element through the open end. The filter assembly also includes a filter cap couplable to the filter body at the inlet end and a filter cap retaining structure to removably secure the filter cap to the filter body while substantially maintaining a relative rotational orientation between the filter cap and the filter body.

### CLAIM TO PRIORITY

This application claims priority to U.S. Provisional Patent Application Ser. No. 60/686,603 filed Jun. 2, 2005 entitled “Sealant Filter” the contents of which are incorporated in their entirety by reference.

### FIELD OF THE INVENTION

The invention relates generally to the field of filters for sealants and adhesives that are pumped through lines at high pressure.

### BACKGROUND OF THE INVENTION

Insulated glass is heavily utilized in modern residential and business construction. In many areas of the country it is required by building code as a mandatory energy conservation measure. A single pane of glass alone has very little insulating value. Multipane insulated glass windows have much greater insulating value.

Insulated glass generally includes two panes of glass separated by a space. The perimeters of the two panes of glass are sealed to one another to eliminate movement of ambient air into the space between the two panes of glass. The space is filled with dehydrated air or with another form of gas.

Traditionally, sealant applied to insulated glass window units have been silicone-based sealants. Silicone-based sealants require a curing time of between several hours and several days before they achieve substantial strength. This has led to the need for large storage facilities in the window and door manufacturing industry in order to allow finished units to set for a sufficient period of time to achieve substantial curing of the sealants before shipment or other handling. Thus, recently, there has been a move to change over to hot applied sealants to minimize curing time. The hot applied sealants and adhesives reduce the need to store completed window and door units while the sealant cures thus reducing overhead and the overall cost of producing windows and doors.

However, hot applied sealant materials tend to include high levels of abrasives and corrosive components. Hot applied sealants generally include substantial concentrations of silicas and other abrasive materials. Thus, the use of hot applied sealants increases the level of wear on mechanical components used to pump, meter and dispense them.

To remain fluid and to flow through pipes and hoses, hot applied sealant materials must be kept hot. Most hot applied sealant materials will remain fluid at temperatures between 200° and 300° Fahrenheit. In order to maintain hot applied sealant materials at an appropriate flowing temperature, the passages through which the hot applied sealant material passes must be heated. Insulation is applied to the exterior of the structures that form the passages to improve energy efficiency. Thus, the hoses through which hot applied sealant material flows are heavily insulated as well as equipped with heating elements to maintain the hot applied sealant at an appropriate temperature. All sealants, whether applied at ambient temperature or at elevated temperature are pumped at high pressures that require high strength hoses and fittings to contain the sealants. Thus, while all sealant hoses are unwieldy, stiff and somewhat difficult to handle insulated, heated hoses are especially difficult in this regard.

In addition, hot applied sealant materials often contain or may contaminated with undesirable foreign material or particulate matter that may find its way into the hot applied sealant material prior to its entry into the application equipment.

Factories in which hot applied sealant materials are used commonly also house cutting tools that may create shavings, chips, sawdust or other particulate matter that can get into the hot applied sealant. The pumps and metering devices that are used in equipment for applying hot applied sealant materials include many devices which operate at high pressure and have closed tolerances between moving parts. Thus, foreign material that may find its way into the hot applied sealant material, at worst, can destroy pumps, valves and metering devices that are utilized in the application of the hot applied sealant. At best, the useful life of the close tolerance, high pressure equipment will be shortened substantially by the presence of foreign material in the hot applied sealant materials.

Thus, it becomes important to filter hot applied sealant material when it is in its fluid state prior to the hot applied sealant material encountering the close tolerance machinery in the application equipment.

When filters are utilized with hot applied sealant materials the filters must be changed periodically as they become clogged. Because the filters and the hot applied sealant material must be maintained at a fluid temperature to allow changing of the filters, there is a certain risk to personnel who are changing the filters. Burns may occur from contact with the hot equipment or fluids. Personnel must be protected from burns that might occur from handling the hot melt filter as well as the hot melt material. Thus, personnel generally wear heavy gloves and other protective clothing that may limit dexterity.

Another problem that arises with filters for hot melt material is that most filters available today that are suitable for this application are arranged so that fluid flows in one end of the filter apparatus passes through the filter element from the outside of the element to the inside of the element and out through an outlet. This leaves particulate matter trapped outside of the filter element in a surrounding container. A filter of this type is disclosed for example in U.S. Pat. No. 5,916,435 issued to Spearman, et al. This arrangement does not present a particular problem when utilized with ordinary fluids that are liquid at room temperature. However, with a hot melt fluid it becomes necessary for the operator to remove the hot melted sealant, which is still very hot, from the inside of the container to remove all the particulate matter from the filter. If the particulate contaminated sealant is not removed the remaining particulate matter will tend to immediately clog the newly replaced filter element.

Thus, it is preferable to arrange a filter so that fluid flows in an inlet to the inside of a cylindrical or conical filter element, out through the filter element and then out through an outlet. This causes particulate matter to be trapped within the filter element so the filter element can be removed and discarded taking the particulate matter with it. A filter of this type is disclosed in U.S. Pat. No. 5,536,402 issued to Kluhsman.

Filters of the type disclosed in Kluhsman still have a continuing problem however, in that, as previously mentioned, the hoses utilized in hot melt application equipment are thick and relatively inflexible. A filter of the type disclosed in the Kluhsman reference requires that the ends of the filter container be removed to gain access to the filter element so that it can be removed and discarded or cleaned. This becomes very difficult with prior art filters because the filter element must be disconnected from the hoses prior to any removal to gain access to the filter element.

In addition, currently available filters are not well adapted to being connected to heating elements in order to maintain the hot applied sealant materials in a fluid state. Further still, currently available filters are not well adapted to accommodate heat sensors to allow for maintenance of the filter element and the contained hot melt sealant material at an appropriate high temperature.

Thus, the sealant application industry would benefit significantly from a filter element that is adapted to operate at high pressures that is readily accessible for changing the internal filter element without the need to entirely disconnect the filter assembly from the heavy and relatively inflexible ambient temperature or hot melt sealant hoses. In addition, it would be beneficial if the filter was of a type that minimizes the necessity to clean out the inside of the filter assembly housing. Further, it would be beneficial to the hot melt sealant application industry if the filter element was readily removed for discard while minimizing danger to personnel removing the filter due the high temperature of the contents of the filter element and hoses.

### SUMMARY OF THE INVENTION

The sealant filter of the present invention solves many of the above problems. The sealant filter generally includes a filter body, a filter cap, a filter shoulder, a retaining nut and a filter element. The filter body is preferably of sufficient strength to withstand a pressure of up to about 3,000 lb/inch². The filter body of the present invention may be formed of stainless steel or another high strength, preferably metallic, material. A metallic material also allows the filter body to transmit heat efficiently from a heating element to maintain the temperature of hot applied sealants that are kept within. The filter cap covers an open end of the filter body to provide an enclosure for the filter element.

The filter of the present invention is configured so that the inlet is located in the filter cap and the outlet is located in an opposite end of the filter body. The filter element is inserted into the filter body from the open end when the filter cap is removed so that fluid flows through the inlet into the interior of the filter element out through the walls of the filter element then through the interior of the filter body and out the outlet. In this way, foreign material is trapped within the filter element and is readily discarded along with the filter element.

The retaining nut may be threaded onto the filter body at the open end thereof in such a way that the retaining nut secures and clamps the filter cap against the open end of the filter body and the open end of the filter element is secured at the open end of the filter body. It is particularly notable in the present invention that the retaining nut is unscrewable separately from the filter cap so that the retaining nut may be turned without the necessity to turn the filter cap and therefore without the necessity to turn or remove a hose connected to the filter cap.

In addition to the outlet, the filter body may include a threaded receptacle for receiving a pressure gauge attached thereto. The pressure gauge is valuable for determining a pressure drop across the filter element. When the pressure drop reaches a predetermined level it signals the need to replace the filter element because it has become clogged.

The filter element of the present invention may be substantially rigid or semi-rigid and may be made of stainless steel mesh or another material adapted to an application that involves high pressure and temperature. The filter element may be substantially circular at one end and may be flattened to a tapered closed end. The filter element may be available in, for example, 30, 60 and 100 mesh sizes. The filter element may be formed from woven material and have a crimped and welded construction. In addition, the filter element may take the form of a perforated or sintered sheet formed to the necessary shape.

Thus, the present invention provides a filter assembly that entraps undesirable particulate debris within the filter element so that the filter element can be removed and discarded without the necessity to clean particulate debris out of the filter assembly itself. In addition, the filter assembly of the present invention can be readily disassembled for replacement of the filter element without the necessity to disconnect the filter assembly from hoses that may be attached thereto. Further, the filter assembly can be disassembled without the need to rotate the filter assembly relative to the hoses that it is connected to.

In addition, in one embodiment, the filter assembly includes a drip edge built into the open end of the filter body that prevents fluid from dripping on to the threads to which the retaining nut attaches thereby preventing sealant from following the threads of the retaining nut.

In another embodiment, the filter assembly includes a multi-piece external collar that may be applied to secure the filter cap to the filter body instead of a retaining nut. The multi-piece external collar may be easier to remove and apply in applications where the filter assembly is located in close quarters because it eliminates the need to swing a large wrench. The multi-piece external collar may include two or more pieces that are assembled together to secure the filter cap to the filter body. In one embodiment of the invention, the multi-piece external collar includes four similar sections that are assembled into a boxlike, four sided external collar to secure the filter body to the filter cap. In addition, because of the high pressures involved in sealant dispensing systems the securement between the filter cap and the filter body needs to withstand the elevated pressures.

Thus, the features of the filter assembly make it easy to open and easy to clean or replace the filter element making it better suited than prior art filters to use with high pressure application of sealants at ambient elevated temperatures. The invention is especially useful when applied is situations that employ hot melt sealants and adhesives.

### BRIEF DESCRIPTION OF THE DRAWINGS

FIG. 1 is a perspective view of a sealant filter in accordance with the present invention.

FIG. 2 is a cross-sectional perspective view of the sealant filter.

FIG. 3 is a perspective view of a sealant filter in accordance with the present invention with parts removed for clarity.

FIG. 4 is a plan view of a filter body in accordance with the present invention.

FIG. 5 is a cross-sectional view of the filter body taken along section line 5-5 of FIG. 4.

FIG. 6 is a perspective view of a filter cap in accordance with the present invention.

FIG. 7 is an elevational view of the filter cap.

FIG. 8 is a plan view of the filter cap of FIG. 7 with internal structures depicted in phantom.

FIG. 9 is a perspective view of another embodiment of the sealant filter in accordance with the present invention.

FIG. 10 is a perspective cross sectional view of the sealant filter depicted in FIG. 9.

FIG. 11 is an exploded view of the sealant filter depicted in FIG. 9.

FIG. 12 is an end elevational view of the sealant filter depicted in FIG. 9.

FIG. 13 is a cross sectional view taken along section line 13-13 of FIG. 12.

FIG. 14 is a partial exploded view of the sealant filter of FIG. 9.

FIG. 15 is a plan view of a four piece external collar in accordance with the present invention.

### DETAILED DESCRIPTION OF THE INVENTION

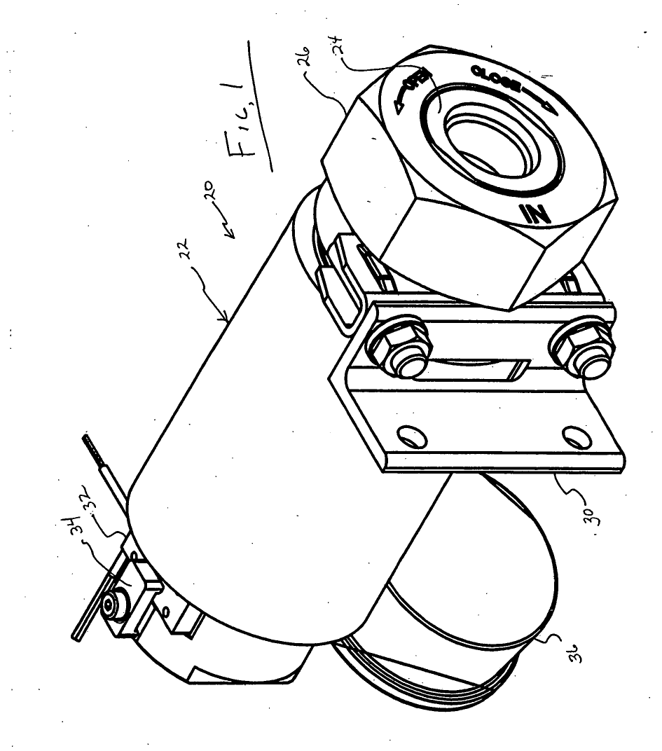

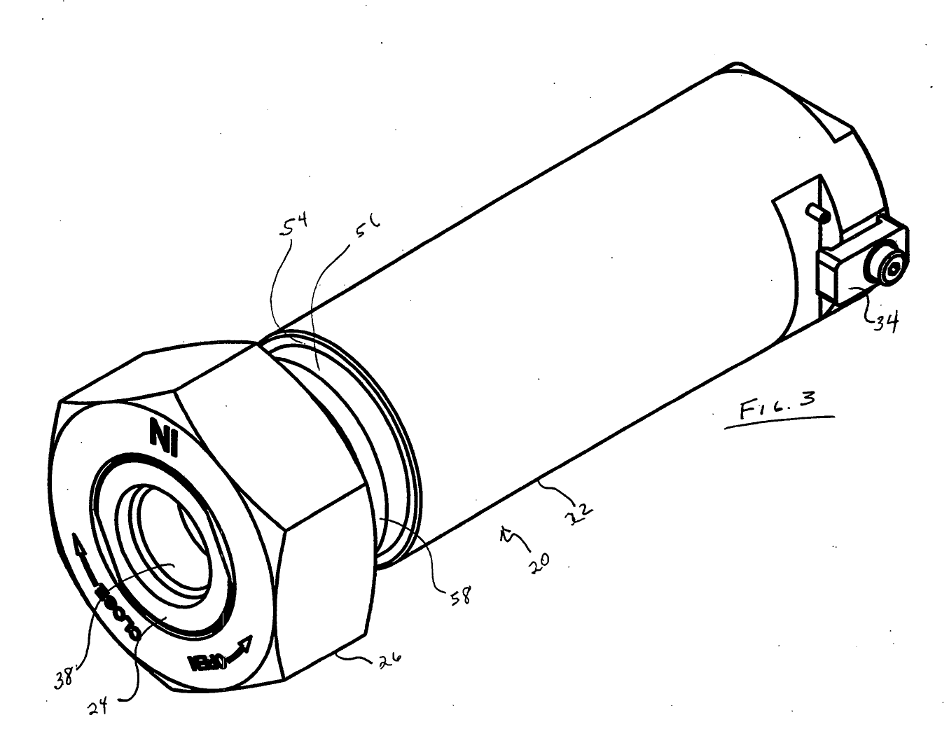

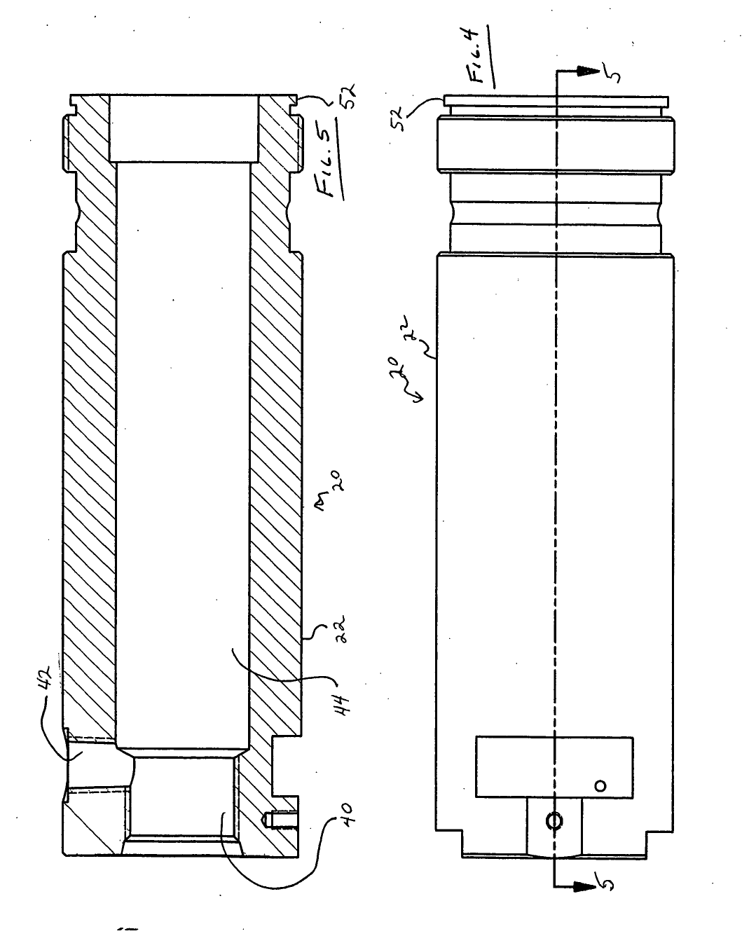

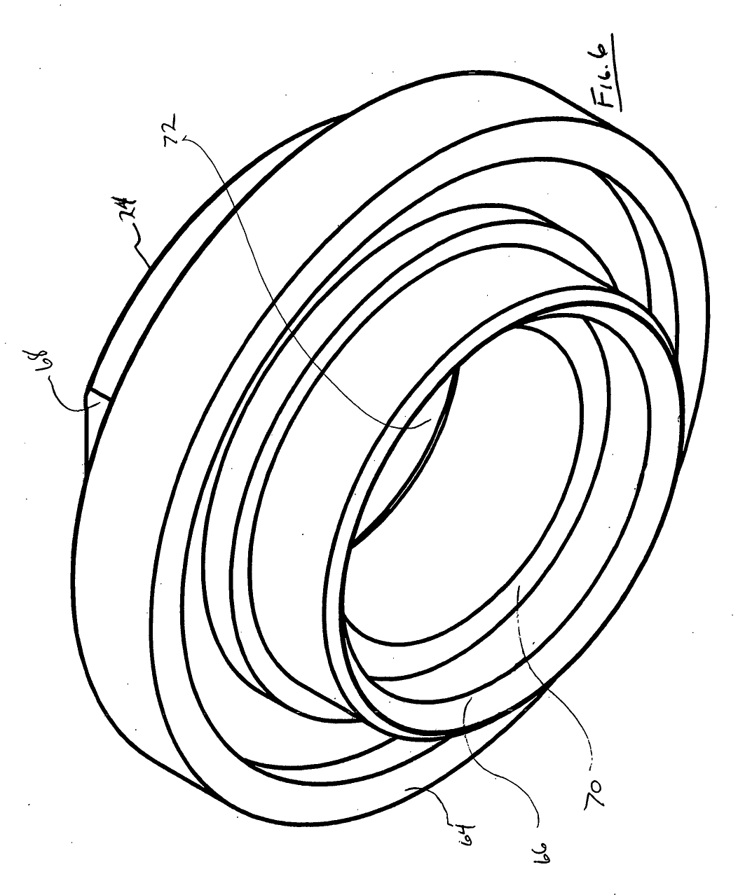

Referring to FIGS. 1-6 an embodiment of sealant filter 20 generally includes filter body 22, filter cap 24, retaining nut 26 and filter element 28. Sealant filter 20 may also include mounting bracket 30, temperature sensor 32, sensor clamp 34 and pressure gauge 36.

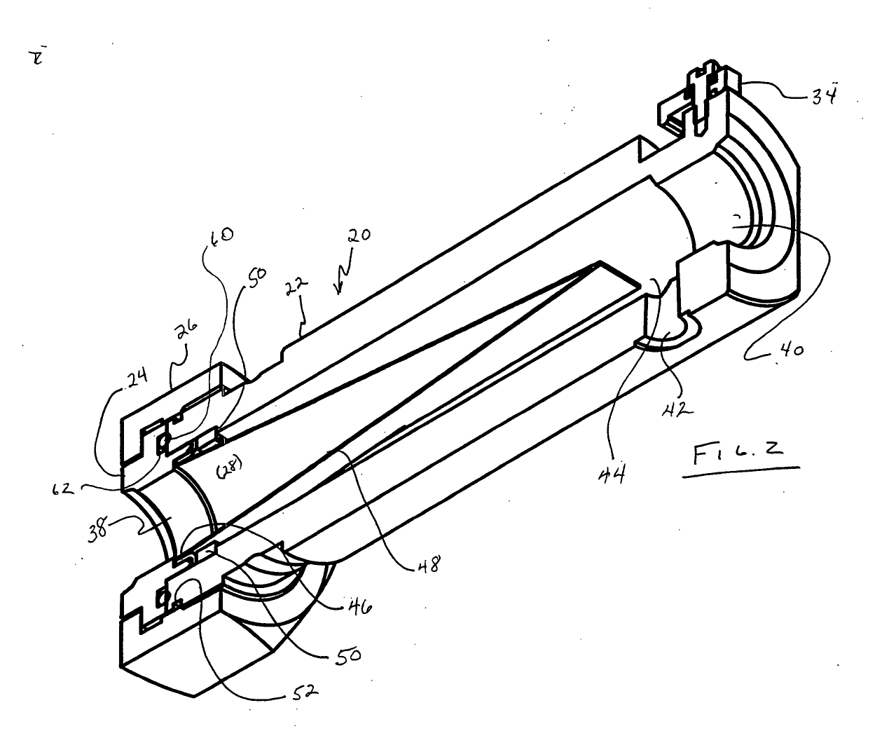

Referring particularly to FIG. 2, filter body 22 defines inlet 38, outlet 40 and gauge port 42. Filter body 22 also defines cavity 44. Filter body 22 may be formed of a material capable of containing high pressures such as, but not limited to, stainless steel. Outlet 40 and gauge port 42 may be threaded to receive threaded attachments to fittings. Other coupling arrangements known in the art may also be utilized. Inlet 38, outlet 40 and gauge port 42 are all in fluid communication with cavity 44. Desirably, the end of filter body 22 surrounding inlet 38 defines drip edge 52 about inlet 38.

Filter element 28 is dimensioned to fit within cavity 44. Filter element 28 generally includes collar portion 46 and sieve portion 48. Sieve portion 48 may be formed from stainless steel mesh, perforated or sintered metal, ceramic or another durable material in various sizes. For example, sieve portion 48 may be made of 30, 60 or 100 mesh of stainless steel mesh material. Collar 46 is substantially circular in form and may rest on filter holder 50. Filter holder 50 may be formed of a resilient gasket material or of a somewhat malleable material such as brass, copper or bronze to facilitate sealing.

Filter cap 24 defines inlet 38 and is dimensioned to secure collar portion 46 of filter element 28 into filter body 22. Inlet 38 may be threaded to receive fittings. It is notable, in this embodiment, that filter cap 24 is separate and independent from retaining nut 26 and that filter cap 24 does not turn with retaining nut 26 when retaining nut 26 is turned.

Retaining nut 26 may be threadedly engageable to filter body 22 and may secure filter cap 24 to filter body 22. Retaining nut 26 may also include an interrupted thread or other engagement structure known to those skilled in the art.

Filter shoulder 50 is sized to be interposed between collar portion 46 and filter body 22. Filter shoulder 50 is a substantially ring-shaped structure formed of a resilient gasket material or of a somewhat malleable material such as brass, copper or bronze to facilitate sealing.

Sealant filter 20 is desirably formed of a material tolerant to high pressure as well as elevated temperature. Hot applied sealant materials typically must be maintained at a temperature of 200°-300° Fahrenheit and sealant filter 20 should be formed of a material that can tolerate that temperature for a long period of time. For example, stainless steel is one material from which sealant filter 20 may be formed.

Referring to FIGS. 2, 4, and 5, filter body 22 may further define clamp groove 54. Clamp groove 54 may include flat portion 56 and depressed portion 58. Filter cap 24 may be sealed to filter body 22 by O-ring 60 received into O-ring groove 62. O-ring groove 62 may be formed in either filter body 22 or filter cap 24.

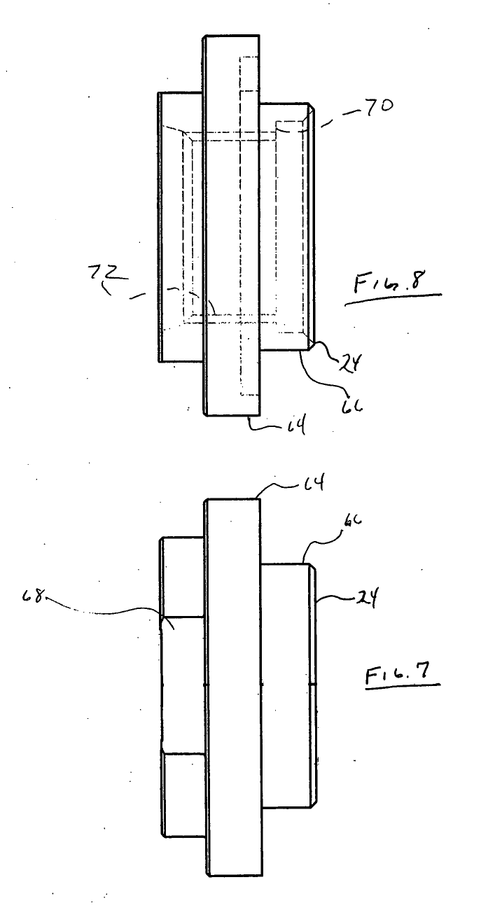

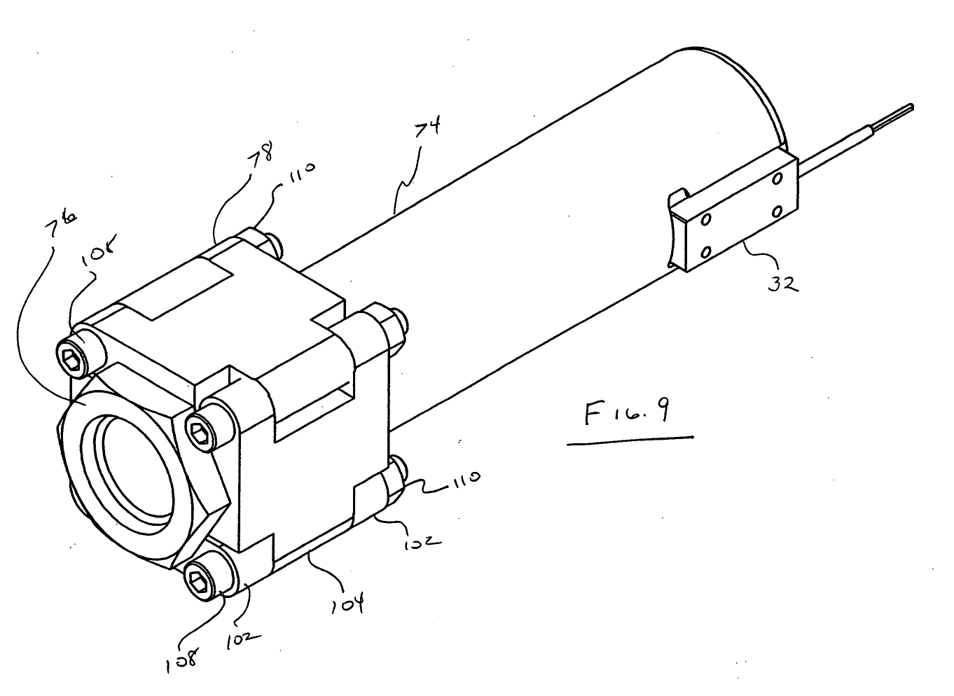

Referring to FIGS. 6, 7 and 8, filter cap 24 defines outer wall 64, inner wall 66, wrench flats 68 and filter collar receiving shelf 70. Inlet 38 of filter cap 24 may include threaded portion 72. Threaded portion 72 is adapted to receive fittings from connecting hoses or pipes.

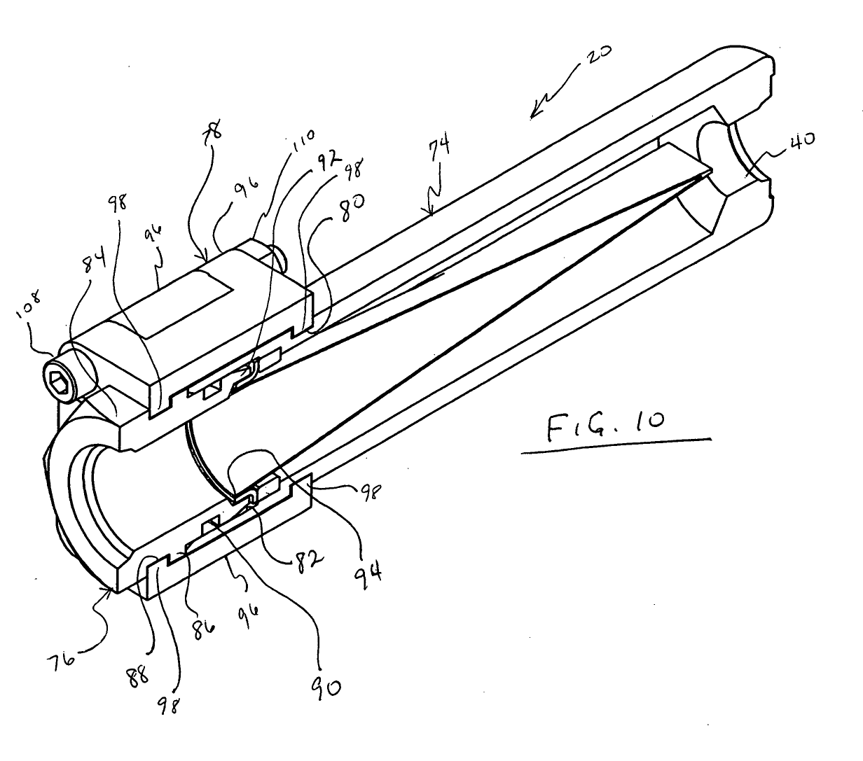

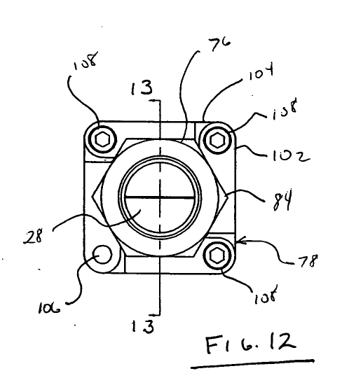

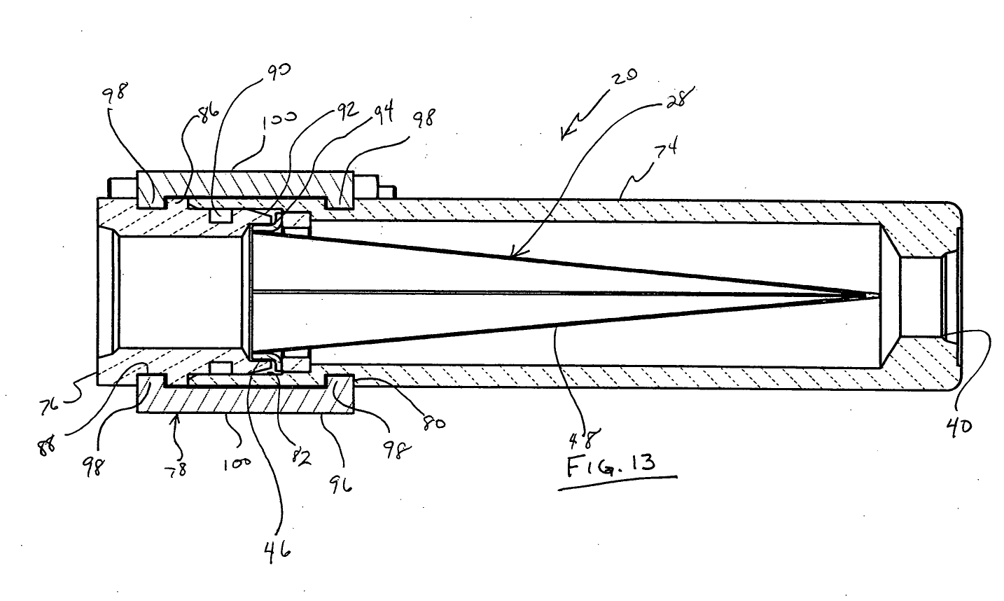

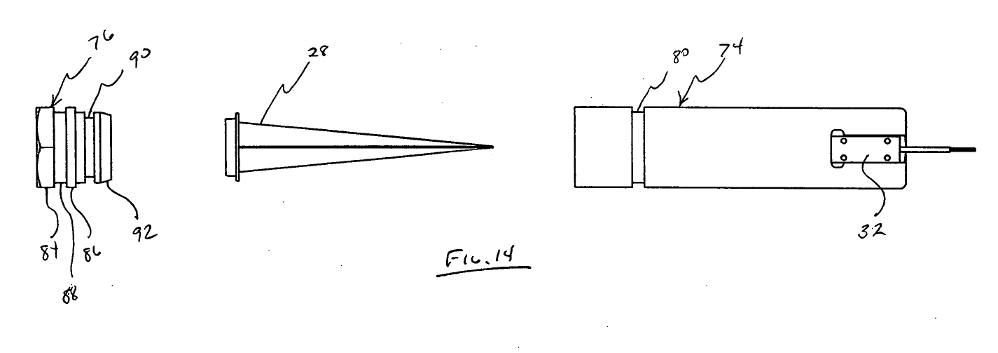

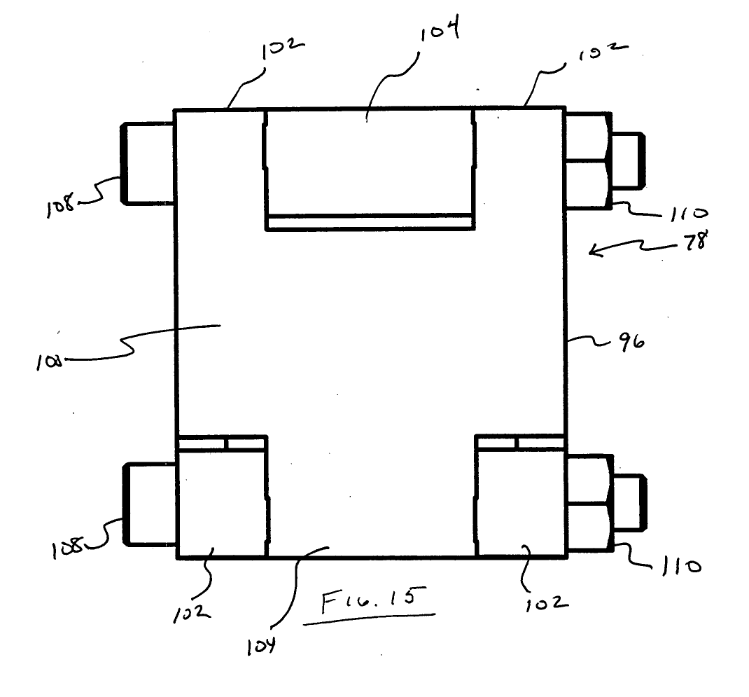

Referring to FIGS. 9-15, another embodiment of sealant filter 20 is depicted. In this embodiment, sealant filter 20 includes filter body 74, filter cap 76 and retaining collar 78. Filter element 28 is similar to that described above.

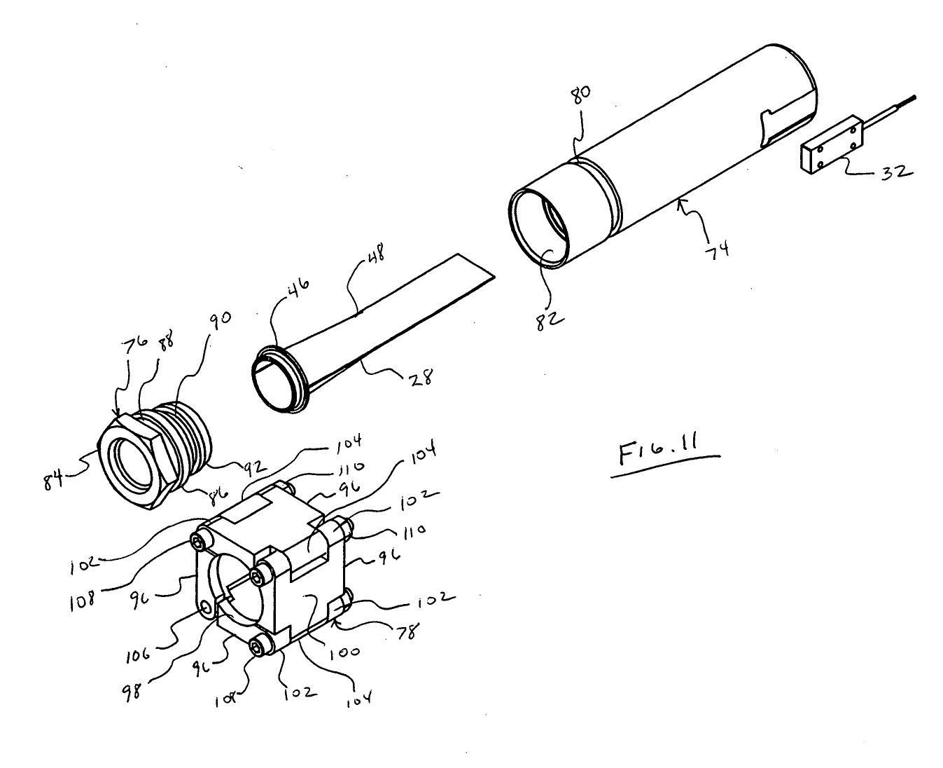

Referring particularly to FIGS. 10, 11, 13, and 14, desirably filter body 74 is a generally cylindrical structure. Filter body 74 is structured to contain fluids at high pressure of about three thousand pounds per square inch. Filter body 74 defines retaining groove 80 and cap receiving portion 82. Retaining groove 80 runs circumferentially around the exterior of filter body 74. Cap receiving portion 82 is recessed and sized to receive a portion of filter cap 76.

Filter cap 76 includes hex portion 84, retaining shoulder 86, retaining groove 88, o-ring groove 90, tapered portion 92, and filter collar receiver 94. Retaining shoulder 86 and retaining groove 88 are robustly constructed to resist the stresses created by elevated pressures.

Retaining collar 78 includes collar segments 96. As depicted here, retaining collar 78 is made up of four collar segments 96. However, retaining collar 78 may be formed of at least two collar segments 96 and may include a larger number of collar segments than four.

Retaining collar 78, as depicted here, is made up of four similar collar segments 96. Collar segments may also be dissimilar in structure. Each collar segment 96 includes retaining ridges 98, plate 100, knuckles 102, and barrel 104. Retaining ridges 98 protrude from plate 100. Retaining ridges 98 may be curved to conform to a segment of a cylinder in order to closely fit filter body 74 and filter cap 76. In this embodiment, two knuckles 102 protrude from plate 100 at a first end and barrel 104 protrudes from plate 100 at a second end. Barrel 104 is sized to fit into a space between knuckles 102. Knuckles 102 and barrel 104 are pierced by bore 106.

Bolt 108 may be passed through bore 106 to secure collar segments 96 together. Bolt 108 may be secured in place with nut 110.

In operation, sealant filter 20 is secured into a line for hot melt or ambient temperature sealant materials. Hot melt or ambient temperature sealant materials flow in through inlet 38 and out through outlet 40. Undesirable debris is trapped on the inside of filter element 28.

When it becomes necessary to replace filter element 28 an operator may unscrew retaining nut 26 and disengage filter cap 24 from filter body 22. An operator may then reach into cavity 44 to grasp filter element 28 with a tool such as needle nose pliers to remove filter element 28. Filter element 28 may be cleaned or discarded and a new filter element 28 or clean filter element 28 may be inserted into cavity 44.

Advantageously, retaining nut 26 can be unscrewed and filter cap 24 separated from filter body 22 to replace filter element 28 without the need to disconnect unwieldy hoses from sealant filter 20. In addition, temperature sensor 32 may be secured to sealant filter 20 at sensor clamp 34.

Drip edge 52 lessens the chance that sealants dripping from cavity 44 will get onto and foul threads where retaining nut 26 engages filter body 22.

Referring to FIGS. 9 through 15, in one embodiment of the invention, sealant filter 20 may be secured into a line for hot melt sealant materials. When it is desired or necessary to replace filter element 28, an operator may unscrew nut 110 from one of bolts 108 and remove one of bolts 108 from bore 106 to release the connection between knuckles 102 and barrel 104. Remaining bolts 108 and nuts 110 may be loosened as necessary to hingedly open retaining collar 78 by bending color segments 96 appropriately.

Filter cap 76 may then be pulled straight out from filter body 74 to expose filter element 28. Notably, filter cap 76 is removable from filter body substantially without altering the rotational orientation between filter cap 76 and filter body 74. Filter element 28 may be removed from the interior of filter body 74 by grasping it with a tool such as needle nose pliers.

When filter element 28 is removed, trapped particulate matter along with hot melt sealant that may be contaminated by trapped particular matter is removed with it retained inside of filter element 28.

An operator may then insert a new or clean filter element 28 into filter body 74 and reconnect filter cap 76 by inserting it straight into filter body 74. Retaining collar 78 may then be replaced to secure filter cap 76 to filter body 74 by reversing the above-described removal procedure.

In an advantageous aspect of the invention, when filter body 74 and filter cap 76 are separated, there is no necessity to rotate them relative to one another, thus making it easier to separate them to replace filter element 28 when dealing with heavy, stiff hoses that are required for hot melt sealants.

The present invention may be embodied in other specific forms without departing from the spirit of the essential attributes thereof; therefore, the illustrated embodiments should be considered in all respects as illustrative and not restrictive, reference being made to the appended claims rather than to the foregoing description to indicate the scope of the invention.

1. A filter assembly for filtering viscous fluid materials, comprising:
a filter body having a hollow structure defining a cavity, an inlet end and an outlet that is couplable to an outlet fitting through which fluid may exit;
a filter element having a sieve portion insertable into the cavity, the sieve portion having an open end and a closed end and a collar structure at the open end of the sieve portion, the collar structure being retainable proximate the inlet end in the filter body such that fluid flows into an interior of the filter element through the open end;
a filter cap couplable to the filter body at the inlet end, the filter cap defining an inlet connection couplable to an inlet fitting; and
a filter cap retaining structure adapted to removably secure the filter cap to the filter body while substantially maintaining a relative rotational orientation between the filter cap and the filter body during assembly and disassembly of the filter cap to the filter body.

2. The filter assembly as claimed in claim 1, in which the retaining structure comprises a segmented retaining collar.

3. The filter assembly as claimed in claim 2, wherein the segmented retaining collar comprises a plurality of segments including a first segment and a second segment and each segment includes a central member having knuckles extending outwardly from a first end and a barrel extending outwardly from an opposing second end, the knuckles of the first segment being spaced apart to receive the barrel of the second segment therebetween when the second segment is located adjacent to the first segment and wherein the first segment and the second segment at least partially surround the filter cap and the filter body to secure the filter cap and the filter body together and to resist pressure inside the cavity.

4. The filter assembly as claimed in claim 1, further comprising a temperature sensor whereby a temperature of the filter assembly can be monitored.

5. The filter assembly as claimed in claim 1, wherein the retaining structure comprises a retaining nut defining retaining nut threads and the filter body defines filter body threads adapted to engage the retaining nut threads and wherein the retaining nut is rotatable to secure the filter cap to the filter body and to resist pressure inside the cavity.

6. The filter assembly as claimed in claim 1, further comprising a substantially ring shaped filter shoulder locatable between the collar structure and the filter body.

7. The filter assembly as claimed in claim 1, further comprising a pressure gauge operably coupled to a pressure gauge port in the filter body whereby a pressure drop across the filter element may be monitored to signal that the filter element needs to be replaced.

8. A filter assembly for filtering viscous fluid materials, comprising:
a filter body having a hollow structure defining a cavity, an inlet end and an outlet that is couplable to an outlet fitting through which fluid may exit;
a filter element having a sieve portion insertable into the cavity, the sieve portion having an open end and a closed end and a collar structure at the open end of the sieve portion, the collar structure being retainable proximate the inlet end in the filter body such that fluid flows into an interior of the filter element through the open end;
a filter cap couplable to the filter body at the inlet end, the filter cap defining an inlet connection couplable to an inlet fitting; and
means for retaining the filter cap to the filter body while substantially maintaining a relative rotational orientation between the filter cap and the filter body during assembly and disassembly of the filter cap to the filter body.

9. The filter assembly as claimed in claim 8, in which the means for retaining the filter cap comprises a segmented retaining collar.

10. The filter assembly as claimed in claim 9, wherein the segmented retaining collar comprises a plurality of segments including a first segment and a second segment and each segment includes a central member having knuckles extending outwardly from a first end and a barrel extending outwardly from an opposing second end, the knuckles of the first segment being spaced apart to receive the barrel of the second segment therebetween when the second segment is located adjacent to the first segment and wherein the first segment and the second segment at least partially surround the filter cap and the filter body to secure the filter cap and the filter body together and to resist pressure inside the cavity.

11. The filter assembly as claimed in claim 8, further comprising a temperature sensor whereby a temperature of the filter assembly may be monitored.

12. The filter assembly as claimed in claim 8, wherein the means for retaining the filter cap comprises a retaining nut defining retaining nut threads and the filter body defines filter body threads adapted to engage the retaining nut threads and wherein the retaining nut is rotatable to secure the filter cap to the filter body.

13. The filter assembly as claimed in claim 8, further comprising a substantially ring shaped filter shoulder locatable between the collar structure and the filter body.

14. The filter assembly as claimed in claim 8, further comprising a pressure gauge operably connected to a pressure gauge port in the filter body whereby a pressure drop across the filter element may be monitored to signal that the filter element needs to be replaced.

15. A method of changing filter elements in a filter assembly, the filter assembly comprising a filter body, a first filter element and a filter cap, the filter cap being substantially fixed in rotation relative to a first conduit from which fluid flows into the filter assembly and the filter body being substantially fixed in rotation relative to a second conduit into which fluid flows from the filter assembly, the method comprising:
inserting a first filter element into the filter body;
identifying a need to change the first filter element;
releasing a filter cap retaining structure that secures the filter cap to the filter body;
separating the filter cap from the filter body while substantially maintaining a relative rotational orientation between the filter cap and the filter body;
removing the first filter element and at least part of fluid contained therein from the filter body;
inserting a second filter element into the filter body;
connecting the filter cap to the filter body while substantially maintaining the relative rotational orientation between the filter cap and the filter body; and
securing the filter cap to the filter body with the filter cap retaining structure.

16. The method as claimed in claim 15, further comprising configuring the retaining structure to comprise a segmented retaining collar; and
disconnecting a first segment from a second segment of the segmented retaining collar.

17. The method as claimed in claim 15, further comprising monitoring a temperature sensor operably connected to the filter assembly.

18. The method as claimed in claim 15, further comprising configuring the retaining structure to comprise a retaining nut defining retaining nut threads and the filter body to define filter body threads adapted to engage the retaining nut threads; and removing the retaining nut from the filter body.

19. The method as claimed in claim 15, further comprising monitoring a pressure gauge operably connected to the filter assembly for a pressure drop across the filter element to signal that the filter element needs to be replaced.
